(19) United States
(12) Patent Application Publication
(10) Pub. No.: US 2019/0314874 A1
(43) Pub. Date: Oct. 17, 2019

(54) METHOD FOR CLEANING PROCESS PLANTS

(71) Applicant: KRONES AG, Neutraubling (DE)

(72) Inventors: Christian BODENSTEINER, Regensburg (DE); Veronika KNÖCHEL, Regensburg (DE); Juergen SOELLNER, Beratzhausen (DE); Eva BEIERLE, Regensburg (DE)

(21) Appl. No.: 16/385,861

(22) Filed: Apr. 16, 2019

(30) Foreign Application Priority Data
Apr. 17, 2018 (DE) 10 2018 205 832.6

(51) Int. Cl. B08B 9/032; B01F 3/04; B01F 5/04

(52) U.S. Cl. CPC B08B 9/0328; B01F 5/0413; B01F 3/0446

(57) ABSTRACT

The present disclosure relates to a method for cleaning a process plant, in particular a process plant in the food and beverage industry, comprising: adding a gaseous medium to a liquid cleaning agent so as to form a cleaning flow, which flows through the process plant parts to be cleaned as a bubble flow or as a plug flow.

### CROSS REFERENCE TO RELATED APPLICATIONS

The present application claims priority to German Application No. 10 2018 205 832.6 entitled “METHOD FOR CLEANING PROCESS PLANTS,” filed Apr. 17, 2019. The entire contents of the above-listed application are hereby incorporated by reference for all purposes.

### PRIOR ART

The present disclosure relates to a method for cleaning a process plant in the food and beverage industry, a Cleaning-in-Place apparatus for cleaning a process plant, as well as a process plant in the food and beverage industry comprising a Cleaning-in-Place apparatus.

In the field of process technology, especially in the food and beverage industry, the regular cleaning of process plants, in particular the cleaning of surfaces in contact with products, is an indispensable measure to ensure that hygiene regulations are complied with and that the manufactured product is harmless to health.

As a rule, so-called Cleaning-in-Place (CIP) cleaning measures are carried out, in which the process plant is cleaned essentially without disassembling the plant. Liquid cleaning agents are here frequently used. It is, however, also known to use a liquid finely distributed in a gaseous medium.

The known cleaning methods are disadvantageous e.g. insofar as they often require multiple cleaning processes and may therefore entail very long cleaning times. Likewise, known cleaning methods may entail a very high consumption of cleaning agents, including a high consumption of media.

### Task

It is therefore the object of the present disclosure to improve a method for cleaning process plants, especially process plants used in the food and beverage industry. By way of example, it is in particular an object to improve a method for cleaning a process plant as regards the efficiency, effectiveness, economy and energy balance of the method or of the cleaning.

### Solution

According to the present disclosure, this is achieved by a method for cleaning a process plant, in particular a process plant in the food and beverage industry, a Cleaning-in-Place (CIP) apparatus for cleaning a process plant in the food and beverage industry, and a process plant in the food and beverage industry comprising a Cleaning-in-Place apparatus. Advantageous embodiments and further developments are the subject matters of the subclaims.

An exemplary method for cleaning a process plant, in particular a process plant in the food and beverage industry, may here comprise the addition of a gaseous medium to at least one liquid cleaning agent so as to form a cleaning flow, and this cleaning flow may flow through the process plant parts to be cleaned as a bubble flow, a slug flow or a plug slug flow or a plug flow.

It follows that the cleaning flow may in particular form a multi-component two-phase flow whose phase distribution can be described e.g. by a bubble flow or a plug flow.

In this way, e.g. turbulences may be caused in the cleaning flow produced by the addition of a gaseous medium to the liquid cleaning agent, these turbulences being able to produce an additional mechanical cleaning effect and to effectively remove even stubborn contaminations, such as biofilms.

In other words, said addition of at least one gaseous medium to a liquid cleaning agent can lead to the formation of a cleaning flow, in particular a turbulent cleaning flow, and to a turbulent bubble flow or plug slug flow.

The at least one gaseous medium for the addition may comprise e.g. pressurized air. Other gaseous media, such as CO₂, are, however, imaginable as well, in particular gaseous media which, for example, have a low solubility in the liquid cleaning agent used. However, it is also imaginable to employ gaseous media having a good solubility in the liquid cleaning agent used.

The phrase “addition of the at least one gaseous medium to a liquid cleaning agent” may, in particular, stand for a targeted and controllable or dosable addition. In other words, the process of adding may e.g. exclude a random mixing process of a gaseous medium and a liquid cleaning agent.

The improved effectiveness of cleaning with the method described by the present disclosure allows, among other things, to minimize the number of cleaning processes required in comparison with known cleaning methods and to thus minimize the time required for cleaning the process plant, a circumstance that can allow reduced production downtimes of the process plant.

For example, compared to conventional cleaning methods, the time required for cleaning can be reduced by up to 50% or more.

In addition, less pressurized air will be necessary in comparison with known cleaning methods, since, in contrast to known cleaning methods that use a cleaning mixture with a gaseous phase component and a liquid phase component, the percentage of liquid phase predominates in the method described here.

The addition of the gaseous medium to the liquid cleaning agent may here be dosed such that the cleaning flow has a mass ratio of liquid cleaning agent to gaseous medium of between 100/1 and 10,000/1, in particular between 500/1 and 5,000/1.

Contrary to the technical prejudice, according to which sufficiently effective cleaning of plants in the food and beverage industry will only be possible when a mixture of gas and liquid is used, in which gas is the dominant component or in which gas serves as a carrier medium for liquid droplets, i.e. in which the gas-liquid mixture forms a droplet flow or a mist flow, internal tests have, surprisingly enough, shown that the use of a gas-liquid mixture, in which the liquid is the dominant component, as is the case with the above-mentioned exemplary cleaning flow, allows to accomplish an equally good or even better cleaning of process plants in the food and beverage industry.

The addition of the gaseous medium to the liquid cleaning agent may also be dosed such that the cleaning flow can be saturated with the gaseous medium, e.g. at or shortly after the dosing point.

For example, the addition of the gaseous medium to the liquid cleaning agent may in particular be dosed such that the cleaning flow can be saturated with the gaseous medium at a predetermined maximum pressure prevailing in the process plant.

For example, a drop in pressure after the saturation, e.g. in a pipeline to be cleaned, may cause part of the gaseous medium to escape from the cleaning flow, and this can lead to improved and more effective cleaning. For example, contaminants caused by flaking off can here be removed more effectively by cleaning.

The above-mentioned exemplary addition of the gaseous medium to the liquid cleaning agent can take place via a nozzle, e.g. via a Venturi-type nozzle, or via a Venturi-type carbonation nozzle. It is, however, also imaginable to use a simple pipe as a device for adding the gaseous medium to the liquid cleaning agent.

Alternatively or additionally, an addition of the gaseous medium to the liquid cleaning agent may be executed in the form of an addition of material, which, when reacting with the liquid cleaning agent, can produce gas bubbles in the liquid cleaning agent.

For example, hydrogen peroxide (H₂O₂) and/or sodium hydrogen carbonate can be added to the liquid cleaning agent.

The exemplary gaseous medium, which can be added to the liquid cleaning agent e.g. by injection, may e.g. comprise pressurized air.

In addition, said exemplary liquid cleaning agent may comprise water, e.g. hot water, acidic and/or alkaline solutions and/or disinfecting liquids.

For example, the temperature of e.g. the liquid cleaning agent, e.g. of the hot water or of an alkaline solution, may be up to 85° C. or more, and the temperature of the liquid cleaning agent, e.g. of an acid solution, may be up to 40° C. or more.

An/the addition of the gaseous medium to the liquid cleaning agent may, for example, take place in the flow path of the cleaning medium after a possibly provided pump of the process plant.

In addition, any existing pumps in the flow path of the cleaning agent or in the flow path of the cleaning flow can be circumvented in a bypass/in bypasses.

In this way, e.g. a/the pump or any existing pumps can be protected against possible damage through the added gaseous medium, e.g. pressurized air.

The addition of the gaseous medium to the liquid cleaning agent may take place e.g. in the vicinity of process plant areas which are difficult to clean and/or in the vicinity of intensely contaminated areas, e.g. upstream of heat exchangers or upstream of heater sections of the process plant.

As a result, in particular the efficiency of the cleaning of problematic or intensely contaminated areas of the process plant can be improved.

The above-mentioned exemplary addition of the gaseous medium to the liquid cleaning agent may take place e.g. in counter-flow to or in co-flow with the flow of the liquid cleaning agent.

Alternatively or additionally, the addition of the gaseous medium may take place transversely to or vertically to the flow of the liquid cleaning agent and/or after an orifice plate in the flow path of the liquid cleaning agent and/or after a 90° curve in the flow path of the liquid cleaning agent.

These modes of addition can lead e.g. to an improved dispersion of the gaseous medium in the liquid cleaning agent as well as to an improved generation of bubbles and turbulences in the liquid cleaning agent, and this, in turn, can contribute to an improved cleaning effect of the cleaning flow.

The above-mentioned exemplary addition of the gaseous medium to the liquid cleaning agent may take place in a line section, which does not come into contact with the product during regular operation of the process plant—e.g. during the production operation. According to an advantageous embodiment, the addition takes place e.g. in a feed line for the liquid cleaning agent. Thus, dispersion elements, such as orifice plates, can be used, which may easily become contaminated during regular operation involving a product.

In addition, the above-mentioned exemplary addition of the gaseous medium to the liquid cleaning agent may take place in a clocked or pulsed mode.

However, also a continuous addition of the gaseous medium to the liquid cleaning agent is imaginable.

After having passed once or more than once through the process plant to be cleaned or through the process plant areas to be cleaned, the cleaning flow, i.e. the mixture of liquid cleaning agent and gaseous medium, can be collected in a collection tank for separating the mixture of liquid cleaning agent and gaseous medium.

In this way, e.g. at least part of the mixture, e.g. at least part of the gaseous medium, can be reused. For example, at least part of the gaseous medium can be collected in a pressure vessel.

An exemplary Cleaning-in-Place (CIP) apparatus for cleaning a process plant, in particular a process plant in the food and beverage industry, may be configured for executing a method for cleaning a process plant comprising at least one, a few, or all of the above described features and method steps.

For example, an exemplary Cleaning-in-Place (CIP) apparatus for cleaning a process plant may comprise devices for adding a gaseous medium to a liquid cleaning agent so as to form a cleaning flow, which can flow as a bubble flow or as a plug flow through the process plant parts to be cleaned.

Exemplary devices for adding a gaseous medium, e.g. pressurized air, to a liquid cleaning agent so as to form a cleaning flow are, by way of example, nozzles, e.g. Venturi nozzles. It is, however, also imaginable to use a pipe for adding a gaseous medium to the liquid cleaning agent.

It follows that an exemplary process plant, e.g. a process plant in the food and beverage industry, may comprise a Cleaning-in-Place (CIP) apparatus for cleaning the process plant; the Cleaning-in-Place (CIP) apparatus may be configured for executing a method for cleaning the process plant according to one of the above described features or method steps.

### BRIEF DESCRIPTION OF THE DRAWINGS

The following figures show, exemplarily:

FIG. 1A: an exemplary Cleaning-in-Place (CIP) apparatus for cleaning a process plant,

FIG. 1B: an exemplary Cleaning-in-Place (CIP) apparatus with a nozzle,

FIG. 2: an exemplary collection tank,

FIG. 3: an exemplary plant.

### DETAILED DESCRIPTION

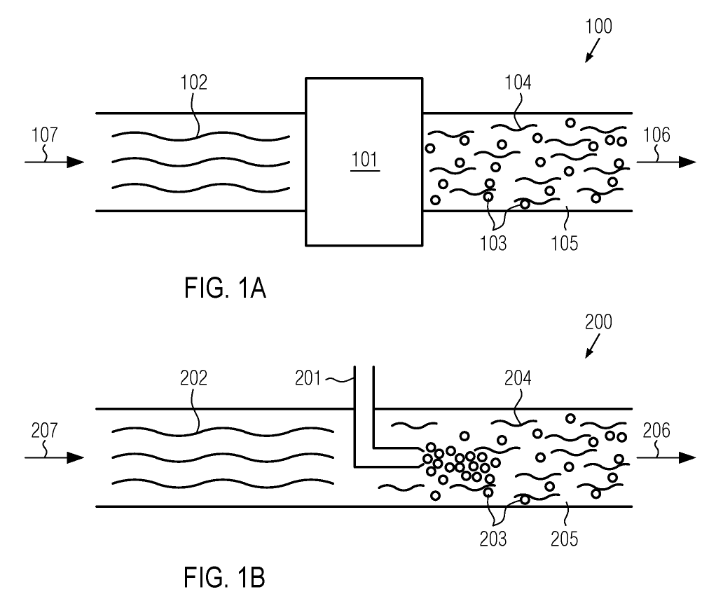

FIG. 1A illustrates, exemplarily and schematically, a possible method step for cleaning a process plant, in particular a process plant of the food and beverage industry, on the basis of an exemplary arrangement of a Cleaning-in-Place (CIP) apparatus 100 for cleaning a process plant.

In this apparatus, an exemplary liquid cleaning agent 102 with an exemplary flow direction 107 within a part of a process plant has added thereto a gaseous medium 103 by means of an exemplary device 101, so as to form a cleaning flow 105 comprising a mixture 104 of liquid cleaning agent and of an added gaseous medium, which can flow as a bubble flow or as a plug slug flow through the process plant parts to be cleaned.

The flow direction 106 of the exemplary cleaning flow may here e.g. be substantially equal to or parallel to the flow direction 107 of the liquid cleaning agent before the addition of the gaseous medium.

Also FIG. 1B shows exemplarily a possible method step for cleaning a process plant, in particular a process plant of the food and beverage industry, on the basis of an exemplary arrangement of a Cleaning-in-Place (CIP) apparatus 200 for cleaning a process plant analogously to the apparatus 100.

As a device for adding a gaseous medium 203 to a liquid cleaning agent 202 so as to form a cleaning flow 204, an exemplary nozzle 201 for injecting the gaseous medium 203, e.g. pressurized air, is here exemplarily shown.

The exemplary nozzle 201 may e.g., as shown, add or inject/feed, the gaseous medium 203 to the liquid cleaning agent 202 in a co-flow, i.e. substantially parallel to the flow direction 207 of the liquid cleaning agent 202.

The flow direction 206 of the exemplary liquid cleaning agent 202 mixes with the added gaseous medium, i.e. the flow direction of the cleaning flow may e.g. also be substantially parallel to the flow direction 207 of the liquid cleaning agent 202 prior to the addition of the gaseous medium.

As mentioned above, the gaseous medium 203 may e.g. also be added to the liquid cleaning agent 202 in a direction opposite to the direction of flow of the liquid cleaning agent.

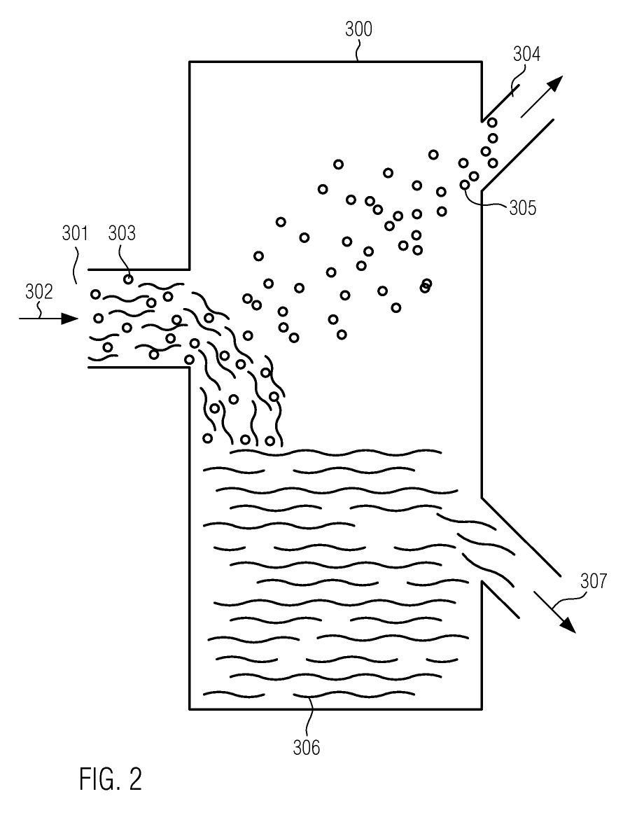

FIG. 2 shows exemplarily a possible collection tank 300 with an inlet 303 for receiving therein an exemplary cleaning flow 301, an exemplary turbulent cleaning flow, having an exemplary flow direction 302 after having passed along a cleaning flow path through process plant areas or parts to be cleaned.

In the collection tank 300, the cleaning flow 301, i.e. the mixture of liquid cleaning agent and gaseous medium, can be divided/segmented/separated into its components, so that the liquid cleaning agent 306 can e.g. collect in the base area of the collection tank, whereas the gaseous medium emitted from/released by/escaping from the mixture of liquid cleaning agent and gaseous medium can be collected/concentrated on top of this liquid cleaning agent.

The collection tank may e.g. have an outlet 307 for discharging the collected liquid cleaning agent as well as a discharge duct 304 for discharging the collected gaseous medium 305 that escaped from the mixture of liquid cleaning agent and gaseous medium.

In order to avoid discharging or recirculating of dirt particles in the liquid cleaning agent, the discharge or the recirculation of the collected liquid cleaning agent can take place below the filling level and below the feed line.

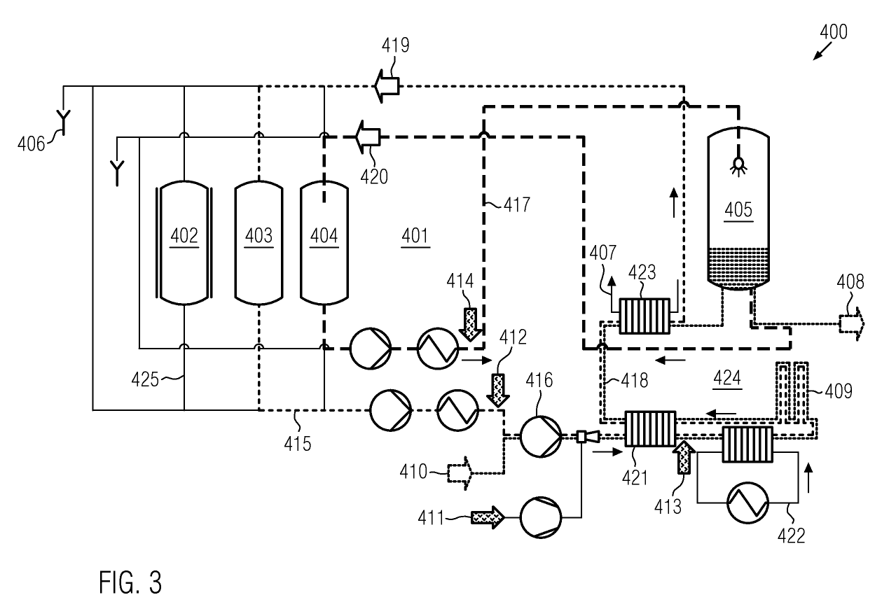

FIG. 3 shows exemplarily a process plant 400 of the food and beverage industry for processing a liquid product, which comprises an exemplary short-time heating unit 424 and an exemplary Cleaning-in-Place, CIP, apparatus 401 that is exemplarily configured for executing above-described steps for cleaning the process plant 400 or the short-time heating unit 424.

The exemplary Cleaning-in-Place, CIP, apparatus 401 may e.g. comprise a plurality of reservoirs or tanks 402, 403, 404 for receiving therein/storing therein and for providing liquid cleaning agents, e.g. a hot water tank 402 for providing hot water as a cleaning agent, an alkaline tank 403 for providing a liquid alkaline cleaning agent and an acid tank 404 for providing a liquid acidic cleaning agent. The provision of the above-mentioned exemplary liquid cleaning agents from the exemplary tanks 402, 403, 404 may take place e.g. via possible feed pumps.

In addition, the exemplary short-time heating unit 424 may have connected thereto an exemplary buffer tank 405, which may be located upstream of e.g. a filler 408.

The product path, provided with reference numeral 418, within the process plant 400 or the short-time heating unit 424 may here e.g. be configured such that, after the product feed 410, the pressure of the liquid product is increased via an exemplary pressure increasing pump 416 and that subsequently the temperature of the product is heated to a desired temperature, e.g. to a temperature for sterilizing the product, e.g. via a heat exchanger 421 and/or an exemplary heater 422 and an exemplary heat retention section 409, and can then be cooled or tempered to a desired product temperature via another possible, exemplary heat exchanger 423 with an optional exemplary cooling circuit 407, before the product can be supplied e.g. to a filler 408 or stored intermediately in an optional buffer tank 405.

Reference numeral 415 identifies an exemplary cleaning path or an exemplary cleaning flow path (identified by a short-dashed line), in the case of which e.g. a liquid cleaning agent from the alkaline tank 403 is used for cleaning the short-time heating unit 424 by means of the exemplary Cleaning-in-Place, CIP, apparatus 401. After the cleaning, the cleaning flow may either be discharged, e.g. via a gully 406, or it may be recirculated into a tank, e.g. the alkaline tank 403, via a return flow 419.

Reference numeral 417 identifies an exemplary further cleaning path or an exemplary further cleaning flow path (identified by a long-dashed line), in the case of which e.g. a liquid cleaning agent from the acid tank 404 is used for cleaning the exemplary product buffer tank 405 by means of the exemplary Cleaning-in-Place, CIP, apparatus 401.

After the cleaning, the cleaning flow may also here be discharged, e.g. via a gully, or it may be recirculated into a tank, e.g. the acid tank 404, via a return flow 420.

Reference numeral 425 identifies an exemplary further cleaning path or an exemplary further cleaning flow path, in the case of which e.g. a liquid cleaning agent from the hot water tank 402 may be used for cleaning the process plant 400 or the short-time heating unit 424. In addition, this exemplary further cleaning flow path 425 may here be routed via or along the above-described line paths or cleaning paths 415 or 417.

As described above, the liquid cleaning agents of the exemplary Cleaning-in-Place, CIP, apparatus 401 may have added thereto, e.g. by injection by means of a Venturi nozzle, at least one gaseous medium so as to form a cleaning flow 415, 417, 425, which may flow as a bubble flow or as a slug flow or as a plug slug flow or plug flow through the parts of the process plant 400 or of the short-time heating unit 424 to be cleaned.

This addition may take place in line sections which come into contact with the product during production operation of the process plant 400 and/or the addition of the gaseous medium may take place in the feed line of the Cleaning-in-Place, CIP, apparatus 401.

FIG. 3 shows exemplarily a few possible optional positions 411, 412, 413, 414 for an exemplary addition of a gaseous medium, e.g. pressurized air, to a liquid cleaning agent, the positions 412, 414, by way of example, being located in a feed line of the Cleaning-in-Place, CIP, apparatus 401, whereas e.g. the positions 411, 413 are located in line sections that may come into contact with the product during production operation of the process plant.

Other positions within the process plant 400 or the short-time heating unit 424 or within the Cleaning-in-Place, CIP, apparatus 401, used for an exemplary addition of a gaseous medium, e.g. pressurized air, to a liquid cleaning agent are, however, imaginable as well.

Three sheets comprising the figures FIG. 1A, FIG. 1B, FIG. 2 and FIG. 3 follow hereinafter.

The respective reference numerals identify the following:

100 exemplary Cleaning-in-Place (CIP) apparatus for cleaning a process plant

101 exemplary device for adding a gaseous medium to a liquid cleaning agent so as to form a cleaning flow

102 exemplary liquid cleaning agent

103 exemplary gaseous medium, exemplary gas bubble, mixed with a liquid cleaning agent

104 exemplary liquid cleaning agent mixed with an added gaseous medium

105 exemplary cleaning flow, exemplary bubble flow or plug slug flow, exemplary multi-component two-phase flow, exemplary mixture of liquid cleaning agent and gaseous medium, exemplary turbulent cleaning flow

106 exemplary flow direction of the cleaning flow

107 exemplary flow direction of the liquid cleaning agent

200 exemplary Cleaning-in-Place (CIP) apparatus for cleaning a process plant

201 exemplary device for adding a gaseous medium to a liquid cleaning agent so as to form a cleaning flow, exemplary nozzle for injecting the gaseous medium, e.g. pressurized air

202 exemplary liquid cleaning agent

203 exemplary gaseous medium, exemplary gas bubble, mixed with a liquid cleaning agent

204 exemplary liquid cleaning agent mixed with an added gaseous medium

205 exemplary cleaning flow, exemplary bubble flow or plug slug flow, exemplary multi-component two-phase flow, exemplary mixture of liquid cleaning agent and gaseous medium, exemplary turbulent cleaning flow

206 exemplary flow direction of the cleaning flow

207 exemplary flow direction of the liquid cleaning agent

300 exemplary collection tank

301 exemplary cleaning flow, exemplary turbulent cleaning flow, exemplary bubble flow or plug slug flow, exemplary multi-component two-phase flow,

exemplary mixture of a liquid cleaning agent and a gaseous medium, e.g. after the mixture has passed along a cleaning flow path through process plant areas or parts to be cleaned

302 exemplary flow direction of the cleaning flow

303 exemplary inlet of the collection tank for receiving therein the cleaning flow

304 exemplary discharge of gaseous medium, which has been separated from the mixture of liquid cleaning agent and gaseous medium

305 exemplary gaseous medium separated from the mixture of liquid cleaning agent and gaseous medium

306 exemplary liquid medium separated from the mixture of liquid cleaning agent and gaseous medium

307 exemplary discharge/exemplary outflow of liquid cleaning agent, which has been separated from the mixture of liquid cleaning agent and gaseous medium

400 exemplary process plant

401 exemplary Cleaning-in-Place, CIP, apparatus

402 exemplary hot water tank

403 exemplary alkaline tank

404 exemplary acid tank

405 exemplary buffer tank

406 exemplary outlet for the cleaning flow, e.g. gully

407 exemplary cooling circuit

408 exemplary product path to a filler/exemplary filler

409 exemplary heat retention section

410 exemplary product feed

411 exemplary supply/addition of a gaseous medium to a liquid cleaning agent

412 exemplary supply/addition of a gaseous medium to a liquid cleaning agent

413 exemplary supply/addition of a gaseous medium to a liquid cleaning agent

414 exemplary supply/addition of a gaseous medium to a liquid cleaning agent

415 exemplary cleaning path/exemplary cleaning flow path/exemplary line path

416 exemplary pressure increasing pump

417 exemplary cleaning path/exemplary cleaning flow path/exemplary line path

418 exemplary product path

419 exemplary return flow of the cleaning flow

420 exemplary return flow of the cleaning flow

421 exemplary heat exchanger

422 exemplary end heater

423 exemplary heat exchanger with cooling circuit

424 exemplary short-time heating unit

425 exemplary cleaning path/exemplary cleaning flow path/exemplary line path

1. A method for cleaning a process plant, comprising:
adding a gaseous medium to a liquid cleaning agent so as to form a cleaning flow, which flows through process plant parts to be cleaned as a bubble flow or as a plug flow.

2. The method according to claim 1, wherein the addition of the gaseous medium to the liquid cleaning agent is dosed such that the cleaning flow has a mass ratio of liquid cleaning agent to gaseous medium of between 100/1 and 10,000/1.

3. The method according to claim 1, wherein the addition of the gaseous medium to the liquid cleaning agent is dosed such that the cleaning flow is saturated with the gaseous medium at a predetermined maximum pressure prevailing in the process plant.

4. The method according to claim 1, wherein the addition of the gaseous medium to the liquid cleaning agent is executed via a nozzle and/or in the form of an addition of material, which, when reacting with the liquid cleaning agent, produces gas bubbles in the liquid cleaning agent.

5. The method according to claim 1, wherein the addition of the gaseous medium to the liquid cleaning agent is executed via a Venturi nozzle.

6. The method according to claim 1, wherein the gaseous medium comprises pressurized air.

7. The method according to claim 1, wherein the liquid cleaning agent comprises water, acidic and/or alkaline solutions and/or disinfecting liquids.

8. The method according to claim 1, wherein the addition of the gaseous medium to the liquid cleaning agent is executed in the flow path of the cleaning agent downstream of a pump of the process plant and/or wherein pumps in the flow path of the cleaning agent or in the flow path of the cleaning flow are circumvented in a bypass or in bypasses.

9. The method according to claim 1, wherein the addition of the gaseous medium to the liquid cleaning agent takes place in a vicinity of process plant areas which are difficult to clean and/or in a vicinity of intensely contaminated areas.

10. The method according to claim 1, wherein the addition of the gaseous medium to the liquid cleaning agent takes place in counter-flow to or in co-flow with the flow of the liquid cleaning agent, and/or wherein the addition of the gaseous medium takes place transversely to or vertically to the flow of the liquid cleaning agent and/or after an orifice plate in the flow path of the liquid cleaning agent.

11. The method according to claim 1, wherein the addition of the gaseous medium to the liquid cleaning agent takes place in a clocked mode.

12. The method according to claim 1, wherein, after having passed through the process plant, the cleaning flow is collected in a collection tank for separating the mixture of liquid cleaning agent and gaseous medium.

13. A Cleaning-in-Place apparatus for cleaning a process plant which is configured for executing a method for cleaning the process plant, the method comprising:
adding a gaseous medium to a liquid cleaning agent so as to form a cleaning flow, which flows through process plant parts to be cleaned as a bubble flow or as a plug flow.

14. A process plant comprising a Cleaning-in-Place apparatus for cleaning the process plant, wherein the Cleaning-in-Place apparatus is configured for executing a method for cleaning the process plant, the method comprising:
adding a gaseous medium to a liquid cleaning agent so as to form a cleaning flow, which flows through process plant parts to be cleaned as a bubble flow or as a plug flow.

15. The method according to claim 1, wherein the process plant is a process plant in the food and beverage industry.

16. The method according to claim 2, wherein the mass ratio of liquid cleaning agent to gaseous medium is between 500/1 and 5,000/1.

17. The method according to claim 9, wherein the addition of the gaseous medium takes place upstream of heat exchangers.

18. The Cleaning-in-Place apparatus according to claim 13, wherein the process plant is a process plant in the food and beverage industry.

19. The process plant according to claim 14, wherein the process plant is a process plant in the food and beverage industry.
